(19) United States
(12) Patent Application Publication
(10) Pub. No.: US 2023/0068648 A1
(43) Pub. Date: Mar. 2, 2023

(54) ELECTRON BEAM SYSTEM, AND METHOD FOR THE ADDITIVE MANUFACTURE OF A WORKPIECE

(71) Applicant: PRO-BEAM GMBH & CO. KGAA, Gilching (DE)

(72) Inventors: Thorsten Löwer, München (DE); Leonardo Sansonetti, Fürstenfeldbruck (DE); Alexander Klassen, München (DE)

(21) Appl. No.: 17/799,718

(22) PCT Filed: Feb. 19, 2021
(86) PCT No.: PCT/EP2021/054237

§ 371 Date: Aug. 15, 2022

(30) Foreign Application Priority Data
Feb. 19, 2020 (DE) 10 2020 104 381.3

(51) Int. Cl. B22F 12/41; B22F 12/00

(52) U.S. Cl. CPC B22F 12/41; B22F 12/38

(57) ABSTRACT

An electron beam system for the additive manufacture of a workpiece having a process chamber which can be evacuated and comprising an electron beam generator which is designed to direct an electron beam onto laterally different locations of a powder bed made of a pulverulent material to be processed in the process chamber. In order to improve the throughput of the electron beam system, the system has at least one prechamber which can be evacuated and which is constantly connected to the process chamber during the operation of the electron beam system in a vacuum-tight manner via a sluice door. Furthermore, at least one movable receiving device for receiving the powder bed and a transport device are provided, said transport device allowing the at least one receiving device to be transported from the prechamber into the process chamber.

### BACKGROUND OF THE INVENTION

### 1. Field of the Invention

The invention relates to an electron beam system for the additive manufacture of a workpiece with a transport device which moves a receiving device between an evacuable process chamber and an evacuable prechamber.

The invention also relates to a method for producing a workpiece in such an electron beam system.

### 2. Description of the Prior Art

Additive manufacturing processes are characterised by the joining of volume elements to form a three-dimensional structure, in particular by a layered structure. Among other things, methods are used in which an energy beam is used to combine a powdery material in a powder bed by selective melting of the individual powder particles point by point and layer by layer to form a 3D structure.

The material can be solidified by sintering the powder particles or by completely melting the powder particles using laser beams or electron beams (for the sake of simplicity, in the following all degrees of melting/sintering will be referred to solely as melting). The processing of metal powder by selective electron beam melting (SEBM) enables the production of metallic structures with complex geometries while at the same time being able to be manipulated quickly and precisely, and a high degree of automation.

The melting of a material with the electron beam takes place in a vacuum since the collision of the electrons with air molecules would lead to high energy losses and scattering. Process chambers of electron beam systems are therefore usually evacuated before operation and operated at pressures of 10⁻⁵ to 10⁻² mbar.

Temperatures of over 1,000° C. are reached on the material surface due to the energy input of the electron beam and optional additional heating of the powder bed. Before the finished workpiece can be removed, it must have cooled down to a certain maximum temperature.

However, depending on the material, the nature of the powder bed and the construction volume, it takes several hours to several days to cool the workpiece in the process chamber in a vacuum. This is because in a vacuum the heat exchange is very low due to the lack of convection, meaning that there are very low cooling rates and thus very long cooling times.

Flooding the process chamber early with air to shorten the cooling time is disadvantageous for various reasons. The hot surface of the workpiece reacts with the oxygen contained in the air. The consequence of this can be uncontrolled changes in the structure of the workpiece, e.g. due to oxidation of the metal.

One way to accelerate the cooling process is to introduce a noble gas such as helium. The inert gas makes it possible to transport heat away more quickly and to avoid reactions with the metal surface. However, noble gases are generally expensive and increase the process costs.

The vacuum must be released at the latest when the workpiece is removed from the process chamber. Restoring the vacuum for the next process takes more time during which the system is not ready for operation. The non-productive times of the process add up to a considerable amount of time and call into question the economic viability of the process.

Known electron beam systems reduce the problem by providing a large number of process chambers. However, this results in a great deal of additional expenditure in terms of equipment.

In other systems, the workpiece is manufactured in a holding device which can itself be evacuated and brought into the process chamber. However, this requires an adaptation of the receiving device to the system and so there is no flexibility of the system and/or the receiving device.

### SUMMARY OF THE INVENTION

The object of the invention is therefore to specify an electron beam system for the additive manufacture of a workpiece which is an improvement with regard to the evacuation problems described. In particular, non-productive times in the manufacturing process should be reduced by avoiding long cooling times.

The object of the invention is also to provide a corresponding manufacturing method for operating this system.

According to the invention, this object is achieved by an electron beam system for the additive manufacture of a workpiece, comprising:
a) a process chamber that can be evacuated;
b) an electron beam generator that is at least partially arranged in the process chamber and is set up to direct an electron beam onto laterally different locations of a powder bed in a powdery material to be processed;
   characterised by
c) at least one prechamber which can be evacuated separately from the process chamber, and which is continuously connected to the process chamber in a vacuum-tight manner via a sluice door when the electron beam system is in operation;
d) at least one movable receiving device for receiving of the powder bed; and
e) a transport device with which the at least one receiving device can be transported from the prechamber into the process chamber.

The system according to the invention has a prechamber in which a movable receiving device including powder bed and/or workpiece can be arranged. The prechamber and the process chamber are connected in a vacuum-tight manner via a sluice door and can thus be evacuated separately from one another and the transport device enables the transition of the receiving device for the powder bed from one chamber to the other.

The fact that the prechamber is continuously connected to the process chamber during operation means in particular that the prechamber essentially remains connected to the process chamber. For maintenance purposes outside of normal plant operation, however, the prechamber can be dismantled from the process chamber.

This enables a controlled cooling phase of the workpiece without long idle times of the system. This is because it is possible to prepare a further powder bed in a further receiving device while the workpiece is still being manufactured in the process chamber in the prechamber without breaking the vacuum in the process chamber. As a result, a finished workpiece can cool down in the prechamber after production, while the process chamber is already being loaded with the next receiving device. In contrast to this, it was previously only known from the machining of existing workpieces to transfer the finished workpieces in and out.

If, for example, two prechambers are used in one process chamber, the movable receiving device for the powder bed can be transported into the second prechamber after the workpiece has been manufactured. Subsequently or during this time, the next movable receiving device can be transported from the first prechamber into the process chamber.

The system according to the invention therefore enables parallel manufacturing and cooling and thus with a considerable time saving in terms of the non-productive time of the additive manufacturing process.

It is preferably provided that the movable receiving device has a construction container which is set up to receive the powder bed and in which the workpiece can be produced additively.

The construction containers of two receiving devices can be dimensioned differently. In this way, movable receiving devices with different sized installation spaces can be introduced into the electron beam system, so that the size of the powder bed can be adapted to the workpiece or workpieces, which in turn allows the use of powdered material, for example, to be optimised. In addition to saving time, this creates additional variability in the system and improves economy through lower powder consumption.

It is preferably provided that the movable receiving device has a storage container for the powdery material.

Because the storage container for the powdery material is also integrated into the receiving device, workpieces can be made of different material one after the other without the process chamber having to be flooded and evacuated. This increases the flexibility of the system. In addition, there is no need to refill the powdery material in the process chamber. Furthermore, the amount of powdery material located in the vacuum chamber can be kept lower in this way, as a result of which the suction loss is reduced.

It is preferably provided that the movable receiving device has a powder application device, in particular a doctor blade system, which is set up to transfer the powdery material from the storage container to the construction container in order to generate the powder bed there for the additive manufacture of the workpiece.

Although it is basically possible to leave the doctor blade system in the process chamber, it is advantageous if the doctor blade system is also carried along by the movable receiving device. This is because the doctor blade system sometimes has a more complex mechanical structure and so it is more easily accessible for maintenance there. The entire doctor blade system is preferably carried along by the movable receiving device. But it is also possible that only one powder application part, such as a squeegee, is carried along by the movable receiving device, while drive actuators of the doctor blade system remain permanently in the process chamber.

It is preferably provided that the transport device is set up to exchange a first movable receiving device, which is initially located in the prechamber, for a second movable receiving device, which is located in the process chamber.

In this context, “exchange” means here only the general arrangement in the respective chamber and not an exchange in exactly the same position. For example, the first receiving device can initially be transported out of the prechamber, next to the second receiving device located in the process chamber. The second receiving device can then then be transported into the prechamber. By appropriately deflecting the electron beam, the manufacturing process can take place both at the original position in the process chamber but also at the other position of the receiving device. By exchanging two movable receiving devices, only one prechamber is required as a lock.

It is preferably provided that the transport device has at least two transport tracks, along which at least two movable receiving devices can be transported back and forth past one another between the prechamber and the process chamber.

Such a transport device reduces the time required to replace the movable receiving devices, since the two receiving devices can be transported in virtually the same step. The two transport tracks can lead through a common sluice door but also through two adjacent sluice doors.

It is preferably provided that the at least two transport tracks run parallel to one another.

This simplifies the construction of the transport device.

It is preferably provided that the prechamber and/or the receiving device have at least one temperature measuring device.

As a result, the cooling process, which can take place in the prechamber in particular, can be monitored. The temperature of the workpiece, the powder bed and/or another component of the system can also be determined.

It is preferably provided for a loading and unloading station to be connected to the prechamber, via which the at least one movable receiving device can be introduced into or removed from the electron beam system.

For this purpose, the prechamber can have a further sluice door through which the receiving device can be introduced into or removed from the prechamber. In the simplest case, the loading and unloading station can comprise, for example, a rail system on which the receiving device can be placed in order to push it into the prechamber.

It is preferably provided that the electron beam system comprises a control unit for the transport device.

Although it is conceivable to set up the transport device for manual operation by the user, it is advantageous if the transport device is operated in an automated manner via a control unit and corresponding actuators. This enables shorter cycle times to be achieved. In particular, the control unit can regulate the process as a function of the measured temperatures and control the transport device and/or the sluice door.

With regard to the method, the object mentioned at the beginning is achieved by a method for additive manufacture of a workpiece which comprises the following steps
a) providing an above-mentioned electron beam system;
b) producing a first workpiece in a first movable receiving device by processing the powdery material in the powder bed by means of electron radiation in the process chamber;
c) loading the prechamber with a second movable receiving device and then evacuating the prechamber;
d) transporting the first movable receiving device from the process chamber into the prechamber;
e) transporting the second movable device from the prechamber into the process chamber;
f) producing a second workpiece in the second movable receiving device by processing the powdery material in the powder bed by means of electron radiation in the process chamber;
g) cooling the first workpiece in the first movable receiving device in the prechamber.

In such a manufacturing process, the workpieces that have already been manufactured can cool down to a certain temperature in accordance with an optimised temporal temperature profile, while another workpiece is being manufactured at the same time. Accelerated cooling can also be achieved through metered ventilation of the prechamber. Since the workpieces manufactured by such a manufacturing process are thus better cooled in accordance with their temperature profile requirements, these workpieces also stand out from workpieces manufactured elsewhere due to their quality.

The following step is preferably provided:

Removing the first movable receiving device together with the workpiece from the prechamber.

Because not only the workpiece but the entire receiving device is removed, the powder bed or the storage container can be prepared more easily for the production of the next workpiece.

Workpieces that are manufactured with the method according to the invention and the system according to the invention can be found, among other things, in the aerospace industry as turbines, pump wheels and gear mounts in helicopters, in the automotive industry as turbocharger wheels and wheel spokes, in medical technology as orthopedic implants and prostheses, as heat exchangers and in tool and mould making applications. The powdery material can include all electrically conductive materials suitable for the electron beam process. Preferred examples are metallic or ceramic materials, in particular titanium, copper, nickel, aluminium and alloys thereof such as Ti-6Al-4V, an alloy of titanium, 6 wt % aluminium and 4 wt % vanadium, AISilOMg and titanium aluminide (TiAl).

Further exemplary materials are nickel-based alloys such as NiCr19NbMo, iron and iron alloys, in particular steels such as tool steel and stainless steel, copper and alloys thereof, refractory metals, in particular niobium, molybdenum, tungsten and alloys thereof, precious metals, in particular gold, magnesium and alloys thereof, Cobalt-based alloys such as CoCrMo, high-entropy alloys such as Al—CoCrFeNi and CoCrFeNiTi, as well as shape-memory alloys.

The powdery material used preferably has an average grain size D50 of 10 μm to 150 μm.

Another aspect of the application focuses on better maintenance options for the system and the avoidance of contamination in a system for the additive manufacture of a workpiece.

In a beam system, especially in an electron beam system, certain parts of the system come into contact with the powdery material that is used for the manufacturing process. There is therefore the risk that when switching to a different material for a subsequent construction process, the new material will be contaminated with powder residues from the previous process. Powder residues can also impair the function of the system.

Regardless of the lock solution mentioned above, a further object of the present invention is to create better maintenance options and/or to reduce the risk of contamination.

This object is achieved by a system for the additive manufacture of a workpiece, comprising:
a) a process chamber, which can preferably be evacuated;
b) a construction container in which the workpiece can be produced;
c) a storage container for powdery material;
d) a powder application device, which is set up to transfer the powdery material from the storage container to a powder bed in the construction container;
e) a beam generator which is set up in the process chamber to direct an energy beam, in particular an electron beam, onto laterally different locations of the powder bed; wherein
f) the powder application device can be removed from the process chamber.

According to the invention, it is thus provided that the powder application device is designed in such a way that it can be easily removed from the process chamber in normal operation between two consecutively produced workpieces and is therefore in particular not permanently installed in the process chamber.

Removable means in this case that the components can be removed from the system without great effort, such as structural changes or with tools. For example, the powder application device can be pulled out of the process chamber along a guide device.

In a preferred embodiment, the doctor blade is fastened to the receiving device and the entire receiving device can be completely removed from the process chamber. The doctor blade and/or the receiving device can preferably be removed completely from the process chamber and/or the system.

It is preferably provided that the system comprises at least one movable receiving device which has the construction container, the storage container and the powder application device.

In this way, the main components of the system that come into contact with the powdery material are combined in a mobile, compact unit. When switching to a different material, the risk of contamination of the new material with powder residues from the previous process can be reduced.

It is preferably provided that the at least one movable receiving device can be transported from the process chamber into and out of the process chamber.

The movable receiving device represents a mobile, compact unit which has advantages in handling when transporting the same into or out of the process chamber. For the transport, a transport device, for example a chain hoist, can be provided, which moves the movable receiving device primarily within the process chamber.

It is preferably provided that the at least one movable receiving device is set up to receive construction containers and/or storage containers with different dimensions, in particular different volumes.

As a result, the space requirement and material consumption can be precisely adapted to the manufacturing process and/or the workpiece. The external dimensions of the receiving device can remain the same. Above all, any means of working with a transport device can remain the same. The dimensions of the containers can differ from receiving device to receiving device. However, the receiving device is preferably constructed in a more modular manner in such a way that containers of different dimensions can be used on a given support frame.

It is preferably provided that all components in contact with the process can be removed from the process chamber.

All components of the system that intentionally come into contact with the powdery material, in particular in preparation for the melting process and/or during the melting process, are considered to be in contact with the process; e.g. the movable receiving device with construction container and powder storage container as well as the powder application device but also any overflow and/or powder residue containers. System parts, such as pumps or process chamber walls, which come into contact unintentionally with circulated powder due to the electrostatic blowing of the powder, are not regarded as parts in contact with the process for the present invention.

According to another aspect of the invention, the object is achieved by a movable receiving device for a system for the additive manufacture of a workpiece from a powdery material, comprising a construction container in which the workpiece can be produced in layers, wherein
a) the movable receiving device is a powder application device, in particular a doctor blade, which is set up to transfer the powdery material from a storage container into a powder bed in the construction container.

It is preferably provided that the storage container for the powdery material is also part of the movable receiving device.

This has the advantage that all of the main components are part of the movable receiving device.

It is preferably provided that the receiving device comprises a support frame which has at least two thermally decoupled sections.

This can be achieved in that the support frame has at least two sections that are not in direct contact with one another. The powder application device can be attached to one section and the construction container can be attached to a second section. This makes temperature management easier. Since higher temperatures arise at the process level during the production of the workpiece than in the surrounding area, the material of the construction container and the neighbouring assemblies are exposed to greater thermal loads and stresses. However, attention must be paid to the highest level of precision around the squeegee, as changes in the position of the squeegee have a major impact on the quality of the workpiece. Material expansion as a result of temperature fluctuations must therefore be kept as low as possible. The support frame with two sections that are thermally decoupled from each other prevents harmful heat from spreading to the doctor blade.

It is preferably provided that the construction container and the powder application device are attached to different sections of the support frame.

With regard to a method, the object is achieved by a method for the additive manufacture of a workpiece, which comprises the following steps:
a) providing one of the above-mentioned radiation systems;
b) producing a workpiece by machining the powdery material with by means of an energy beam in the process chamber; and
c) removing the powder application device from the process chamber.

As a result, the powder application device can be easily serviced and, in particular, cleaned of powder residues.

The features and advantages last mentioned with regard to a removable powder application device are advantageous both in electron beam systems and in laser beam systems. In particular, these features and advantages are also applicable to the systems mentioned at the start of the application with a prechamber and a process chamber and in some cases are particularly advantageous. The applicant therefore reserves the right to combine these features and advantages with the features and advantages of the systems mentioned above.

### BRIEF DESCRIPTION OF THE DRAWINGS

Exemplary embodiments of the invention are explained in more detail below with reference to the drawings, in which:

FIG. 1 shows a schematic view of an electron beam system according to the invention for the additive manufacture of a workpiece;

FIG. 2 shows a side view of the electron beam system;

FIG. 3 shows a plan view of the electron beam system;

FIG. 4 shows an isometric view of a receiving device for the electron beam system;

FIG. 5 shows a side view of an electron beam system according to another exemplary embodiment with two prechambers;

FIGS. 6a-6d are plan views of various embodiments of the electron beam system with different arrangements of the prechamber;

FIG. 7a shows a side view of an electron beam system with a vertical arrangement of the prechamber;

FIG. 7b shows a side view of an electron beam system with a vertical arrangement of the prechamber;

FIG. 8a shows an isometric view of an embodiment of the receiving device for the electron beam system,

FIG. 8b shows an isometric view of a system for the additive manufacture of a workpiece with a movable receiving device.

### DESCRIPTION OF PREFERRED EXEMPLARY EMBODIMENTS

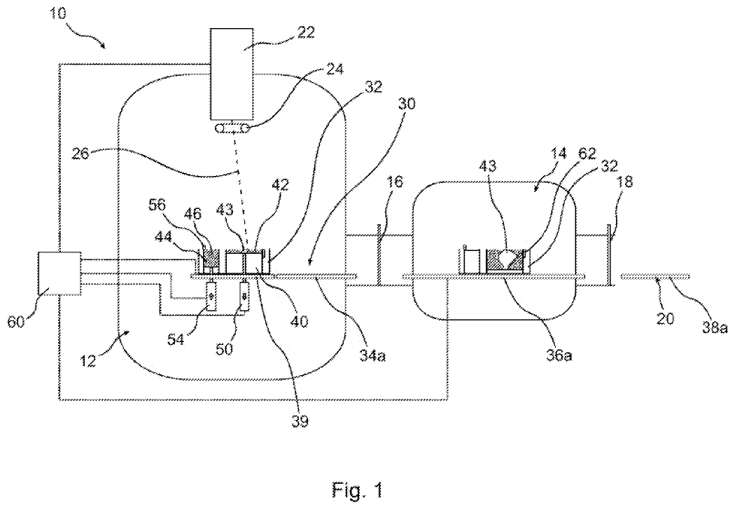

FIG. 1 schematically shows the principle of an electron beam system 10 according to the invention, which comprises a process chamber 12 and a prechamber 14 which is connected to the process chamber 12 via a sluice door 16.

Both the process chamber 12 and the prechamber 14 are defined by vacuum housings which can be evacuated to pressures in the range from 10⁻⁵ to 10⁻² mbar by means of generally known suction devices and vacuum pumps, which are not shown in detail. When the sluice door 16 is closed, the process chamber 12 and the prechamber 14 can, however, be evacuated and ventilated separately from one another. For this purpose, the electron beam system 10 can have a gas inlet, not shown here, for an inert gas, for example, on the process chamber 12 and/or the prechamber 14.

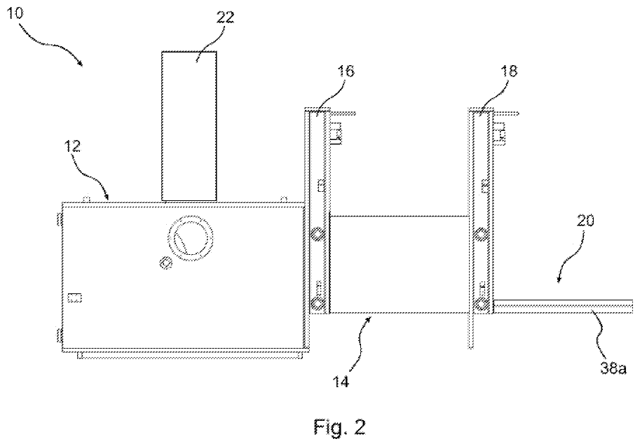

In addition, a further sluice door 18 is provided on the prechamber 14 to an optional loading and unloading station 20 arranged outside the prechamber 14 (see also FIG. 2).

Usually arranged on a flange of the vacuum housing, the electron beam system 10 has an electron beam generator 22 together with a deflection device 24, with the aid of which an electron beam 26 can be generated and deflected in the process chamber 12.

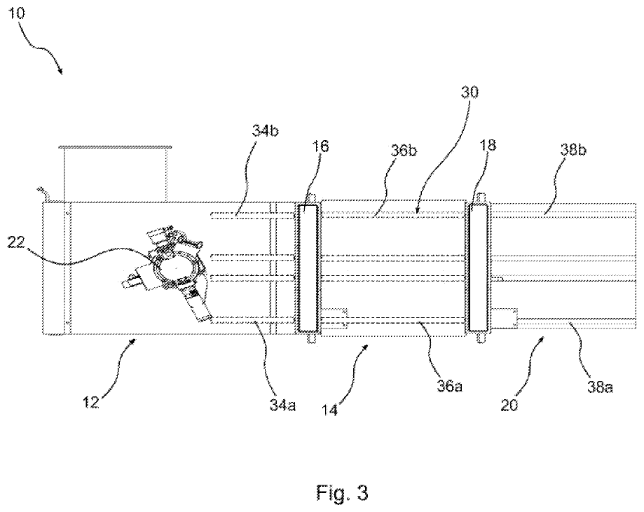

As can be seen from FIGS. 1 and 3, in the exemplary embodiment shown here, rails 34a, 34b, 36a, 36b are provided as a transport device 30 for a movable receiving device 32 in the process chamber 12, in the prechamber 14 and as part of the loading and unloading station 20, 38a, 38b.

The rails 34a, 34b, 36a, 36b, 38a, 38b are interrupted in the area of the two sluice doors 16 and 18, so that when the sluice doors 16 and 18 are closed, the rails 34a, 34b are arranged fully in the process chamber 12 and the rails 36a, 36b fully in the prechamber 14.

The transport device 30 makes it possible to transport the movable receiving device 32 back and forth between the prechamber 14 and the process chamber 12 and if necessary the loading and unloading station via actuators 40, which are not detailed here, such as driven rollers.

In addition, it can be seen from FIG. 3 that the transport device 30 with the rails 34a, 36a, 38a and the rails 34b, 36b, 38b has two parallel transport tracks, so that two movable receiving devices 32 can be transported past one another from the prechamber 14 into the process chamber 12 and back.

In the process chamber 12, a coordinate table 39 adjoins the transport device 30, which can laterally position and move the receiving device 32 in the process chamber 12.

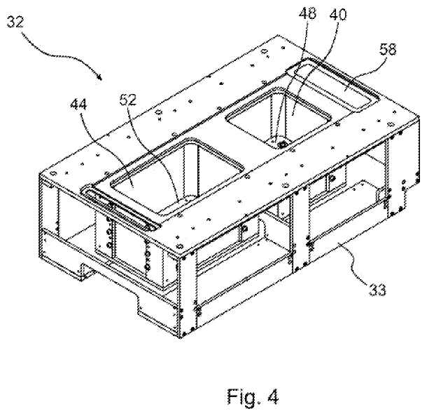

Such a movable receiving device 32 is shown in FIG. 4.

The receiving device 32 firstly has a support frame 33 as a basic component, with which the transport device 30 interacts.

The receiving device 32 also has a construction container 40 in which a powder bed 42 (see FIG. 1) can be received, from which a workpiece 43 can be produced in an additive manufacturing process (3D printing).

Furthermore, the receiving device 32 comprises a storage container 44, which is arranged here next to the construction container 40, in which powdery material 46 is stored.

Both the construction container 40 and the storage container 44 are used as separate components in the support frame 33 and can thus be selected individually for each manufacturing process, i.e. in particular with different sizes. Alternatively, the support frame 33 and the containers 40, 44 can also be permanently attached or even designed as a single piece, so that the receiving device 32 is exchanged in its entirety depending on the manufacturing process.

The construction container 40 for its part comprises a movable base plate 48 which can be raised and lowered via a reciprocating piston 50 arranged in the process chamber 12.

The same applies to the storage container 44, which also has a movable base plate 52 which can be raised and lowered via a second reciprocating piston 54.

Above the two containers 40, 44 a squeegee 56 is provided as a powder application device, with which the powdery material 46 as the uppermost loose layer can be doctored from the storage container 44 to the construction container 40 and evenly applied to a powder bed 42.

The two base plates 48 and 52 are moved in opposite directions, layer by layer, so that the construction container 40 gradually becomes larger and the storage container 44 becomes smaller according to the amount of powder required.

In the simplest design, the two containers 40, 44 have the same overall cross-section. In the case of different overall cross-sections, the movement of the base plate 52 of the storage container 44 must be adapted accordingly to the required amount of powder.

Both the storage container 44 and the powder application device can alternatively also be arranged in the process chamber 12 independently of the receiving device 32. Furthermore, the receiving device 32 can have a powder overflow 58 and a heat shield above the construction container 44.

A control unit 60 is connected to the essential components of the electron beam system 10, in particular to the electron beam generator 22, the actuators of the transport device 30, the sluice doors 16, 18 and the reciprocating pistons 50, 54 in order to control the entire manufacturing process.

The manufacturing process according to the invention works as follows:

To produce a workpiece 43 in the electron beam system 10 according to the invention, a receiving device 32 with a construction container 40 for receiving a powder bed 42 is positioned in die process chamber 12 via the transport device 30.

The powdery material 46 is arranged in the storage container 44.

In the next step, the process chamber 12 is evacuated. After the target pressure has been reached, the manufacturing process of the workpiece 43 begins. For this purpose, the powder application device is used to apply layer by layer of the powdery material 46 in the construction container 40, and each layer is partially solidified with the electron beam 26.

The movement of the electron beam 26 relative to the powder bed 42 can take place by deflecting the electron beam 26 with the deflection device 24 or by moving the coordinate table 39.

Optionally, the powdery material 46 is preheated in a preheating step before the melting step in order to avoid powder losses and process interruptions due to electrostatic blowing of the material 46.

While the first workpiece 43 is being manufactured in the evacuated process chamber 12, the next construction container 40 and possibly the next storage container 44 can be prepared in a further receiving device 32 outside the electron beam system 10. This second receiving device 32 is then placed in the prechamber 14, it being possible for the sluice door 16 to the process chamber 12 to remain closed. Then the prechamber 14 is also evacuated.

Since each movable receiving device 32 can be prepared individually, the storage container 44 can also be filled with a different material 46 in each case. Thus, different workpieces 43 made of different materials can be produced one after the other.

In order to minimise powder consumption, construction containers 40 are provided with different volumes, which are selected depending on the size of the workpiece 43 and can be introduced into the electron beam system 10 by means of the receiving device 32.

After completion of the first workpiece 43, the sluice door 16 between the prechamber 14 and the process chamber 12 is opened. The finished workpiece 43 is transported into the prechamber 14 on a transport track of the transport device 30. The second receiving device 32 is transported into the process chamber 12 on the second transport track.

While the manufacturing process of the second workpiece 43 now begins in the process chamber 12, the first workpiece 43 can cool down in the prechamber 14. This process can be accelerated or precisely defined by introducing an inert gas such as helium. The cooling process of the workpiece 43 is monitored by temperature measuring devices 62 placed in the electron beam system 10 and/or on the receiving device 32.

In order to monitor the process, in particular the cooling process, the temperature is measured at various points in the electron beam system 10 and at the receiving device 32 by means of temperature measuring devices 62. Preferred measuring points include on the base plate 48 of the construction container 40, on the walls of the construction container 40, the storage container 44 and/or the powder overflow 58, on the doctor blade 56, in particular a doctor blade carrier and/or along the doctor blade rail, and combinations of these. Temperature measuring devices 62 can also be attached in the chambers, for example on a side wall or ceiling of the prechamber 14 or process chamber 12.

In one embodiment of the invention, the control unit 60 is designed to monitor the cooling down and automatically flood the prechamber 14 when a certain temperature is reached, to open the sluice door 18 and to transport the receiving device 32 out of the prechamber 14.

A receiving device 32 can then be prepared again and placed in the prechamber 12.

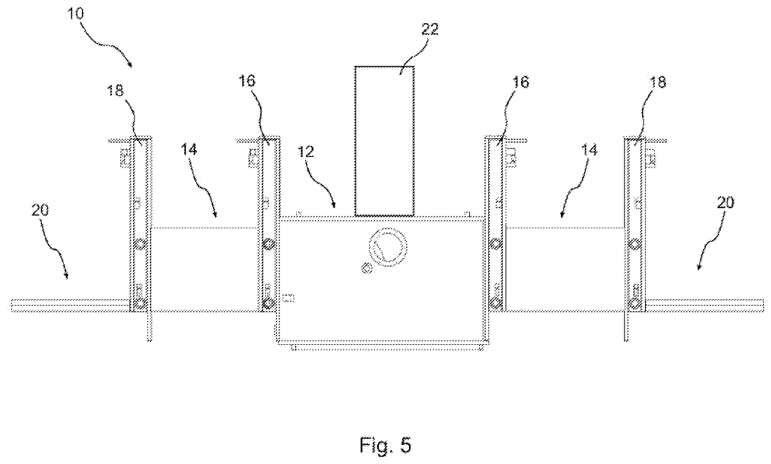

FIG. 5 shows an embodiment of the electron beam system 10 with two prechambers 12. In this embodiment, the transport device 30 can have one, two or four transport tracks. With this system, it is possible to further reduce the time required for cooling per workpiece 43, since several workpieces 43 can cool down in several receiving devices 32 at the same time.

When using two prechambers 14, the transport device 30 can also be equipped with only one transport track, so that, in the continuous flow principle, one prechamber 14 is always used for loading and the other prechamber 14 is always used for cooling and unloading. This reduces the complexity of the transport device 30.

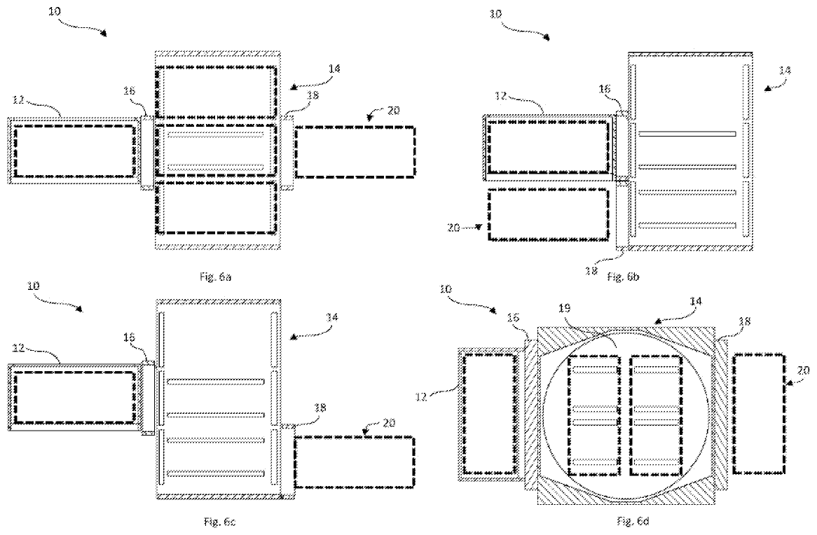

FIGS. 6a-d and 7 show embodiments of the electron beam system 10 with a reduced volume of the process chamber 12 and optimised transport routes of the receiving device 32.

The process chamber 12 of the embodiments shown in FIGS. 6a-d and 7 is designed to accommodate precisely one movable receiving device 32.

FIG. 6d shows an embodiment of the electron beam system 10 with a turntable in the prechamber.

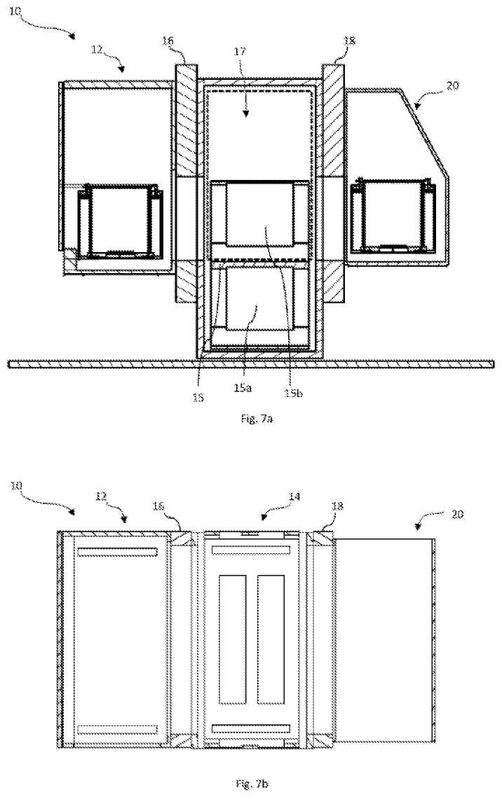

The loading and unloading station 20 can, as shown in FIG. 7, be designed in the form of a closed workspace. The loading and unloading station 20 is preferably a glove box with a powder suction system for the safe unpacking of the workpiece. The loading and unloading station 20 can be designed in the form of a transport unit that can dock with the prechamber.

FIG. 7 shows an embodiment of the electron beam system 10 with a vertical arrangement of the prechamber 14. The prechamber 14 is provided with an elevator 15. The elevator is designed to accommodate at least two movable receiving devices 32 arranged vertically one above the other. The prechamber shown in FIG. 7 has two holding positions for the elevator. In FIG. 7 the elevator 15 is in the lower position and enables the transport from the loading and unloading station 20 to the second loading level 15b of the elevator. The first loading level 15a of the elevator is also designed to accommodate a movable receiving device 32. The upper holding position has the reference symbol 17 in FIG. 17.

According to one possible operating mode, the elevator 15 is equipped with a receiving device 32 and the prechamber 14 is evacuated. The sluice door 16 is then opened and the receiving device 32 is transported into the process chamber. Sluice door 16 is closed again. During the processing of the powder with the electron beam in the process chamber, the sluice door 18 of the prechamber 14 is opened and the elevator 15 is equipped with a further movable receiving device 32. The sluice door 18 is then closed and the prechamber 14 is evacuated.

Alternatively, the elevator 15 can already be equipped with two receiving devices when loading. For this purpose, the elevator is moved from the first to the second stop position or vice versa.

Before finishing the powder processing step, the elevator is brought into a position in which the still vacant loading level and the sluice door 16 are connected. After completion of the powder processing step, the sluice door 16 is opened and the receiving device with the processed powder is transported from the process chamber 12 into the vacant position of the elevator. The elevator is then moved, and the receiving device 32 is transported with the unprocessed powder into the process chamber and processed with the electron beam.

During the powder processing step of the second receiving device, the hot receiving device 32 with the processed powder remains in the prechamber and cools down. In the case of supported cooling processes, the receiving device is brought into an advantageous position, e.g. in the upper area of the prechamber or near the inlet of the coolant.

When the desired temperature is reached, or before the end of the powder processing step of the second receiving device, the elevator is brought into a suitable position, the sluice door 18 is opened and the receiving device is transported out of the prechamber. Then a third receiving device can be brought into the prechamber, the sluice door 18 closed and the prechamber evacuated. The exchange with the receiving device with the processed powder takes place in the same way as described above. The process can be repeated any number of times.

The vertical embodiment of the prechamber is particularly advantageous because in addition to the improved use of the electron beam system with regard to the dwell time and evacuation problems, the space requirement, especially with regard to the footprint of the system, is reduced.

As an alternative to this, the electron beam system 10 can be designed with two prechambers 14 and two transport tracks. In one embodiment of the invention, the electron beam system 10 comprises a multiplicity of process chambers 12 and prechambers 14, between which the movable receiving devices 32 according to the invention are moved back and forth with the aid of the transport device 30.

By parallelizing the manufacturing and cooling process, the dwell time of the workpiece 43 in the process chamber 12 can be significantly reduced and thus the utilisation of the electron beam system 10 can be optimised.

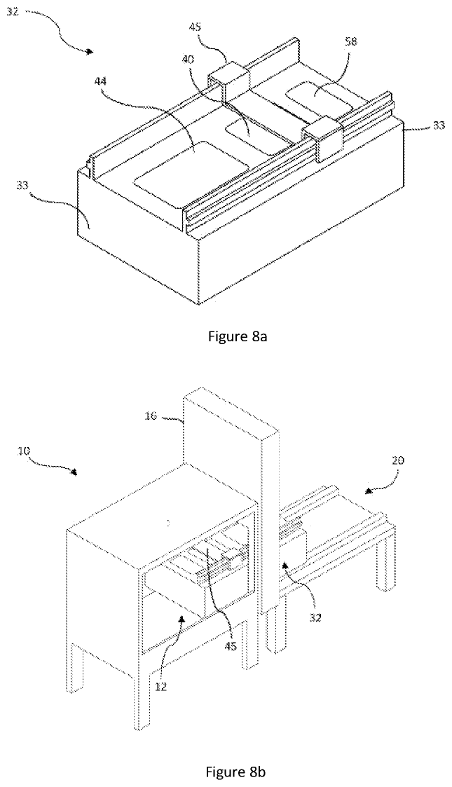

FIG. 8a shows an isometric view of a preferred embodiment of the movable receiving device 32 for the electron beam system.

This movable receiving device 32 comprises a support frame 33 on which a construction container 40, a storage container 44 and a powder overflow 58 as well as a doctor unit as a powder application device 56 are received.

The doctor unit here has one or more squeegees 45 which can be moved along rails via a squeegee carrier. Actuators for moving the doctor blade 45, on the other hand, are arranged in the interior of the process chamber 12 and are not shown in the figures.

It is also not evident in the figures that the support frame 33 has two sections which are thermally decoupled from one another. The doctor blade system 45 and the construction container 40 are not attached to the same section, so that they are thermally decoupled.

FIG. 8b shows an isometric view of a system 10 for the additive manufacture of a workpiece with a movable receiving device 32.

The movable receiving device 32 can be completely removed from the system 10 through the door 16. In this embodiment, the device 32 can be pushed out of the process chamber 12 along rails. No conversion steps whatsoever are necessary in order to remove the movable receiving device 32.

The actuators for the reciprocating pistons 50 and 54 (see FIG. 1), for moving the doctor blade 45 and optionally for a transport device, remain in the process chamber 12 and have a suitable interface to the movable receiving device 32.

An evacuable prechamber as well as a loading and unloading station are optional here, but they make handling easier and shorten non-productive times in the manufacturing process.

Due to the complete removal of the movable receiving device 32 service activities such as cleaning, repair, etc. are significantly simplified. The better accessibility reduces the risk of contamination with foreign particles when changing materials.

What is claimed is:

1. An electron beam system for the additive manufacture of a workpiece, comprising:
a) a process chamber which can be evacuated;
b) an electron beam generator which is set up in the process chamber directing an electron beam onto laterally different locations of a powder bed made of a powdery material to be processed;
wherein
c) at least one prechamber which can be evacuated and which can be used during operation of the electron beam system, is continuously connected to the process chamber in a vacuum-tight manner via a sluice door;
d) at least one movable receiving device for receiving the powder bed; and
a transport device with which the at least one receiving device can be transported from the prechamber into the process chamber.

2. The electron beam system according to claim 1, wherein the movable receiving device has a construction container which is set up to receive the powder bed, and in which the workpiece can be produced additively.

3. The electron beam system according to claim 2, wherein the movable receiving device has a storage container for the powdery material.

4. The electron beam system according to claim 3, wherein the movable receiving device has a powder application device which is set up to remove the powdery material from the storage container to be transferred into the construction container in order to generate the powder bed there for the additive manufacture of the workpiece.

5. The electron beam system according to claim 1, wherein wherein the transport device is set up to exchange a first movable receiving device, which is initially located in the prechamber, for a second movable receiving device, which is located in the process chamber.

6. The electron beam system according to claim 1, wherein wherein the transport device has at least two transport tracks, along which at least two movable receiving devices are transportable back and forth past one another between the prechamber and the process chamber.

7. The electron beam system according to claim 1, wherein wherein the prechamber and/or the receiving device has at least one temperature measuring device.

8. The electron beam system according to claim 1, wherein wherein a loading and unloading station is connected to the prechamber, via which the at least one movable receiving device is introduced into the electron beam system or can be removed from this.

9. A method for additive manufacture of a workpiece comprising the following steps:
a) providing an electron beam system according to any one of the preceding claims;
b) producing a first workpiece in a first movable receiving device by processing the powdery material in the powder bed by means of an electron beam in the process chamber;
c) equipping the prechamber with a second movable receiving device and then evacuating the prechamber;
d) transporting the first movable receiving device from the process chamber into the prechamber or into another prechamber;
e) transporting the second movable device from the prechamber into the process chamber;
f) producing a second workpiece in the second movable receiving device by processing the powdery material in the powder bed by means of an electron beam in the process chamber; and
g) cooling of the first workpiece in the first movable receiving device in the prechamber.

10. The method according to claim 9, further comprising the step of:
a) removing the first movable device together with the workpiece from the prechamber.

11. A system for the additive manufacture of a workpiece comprising:
a) a process chamber which can preferably be evacuated;
b) a construction container in which the workpiece can be produced;
c) a storage container for powdery material;
d) a powder application device which is set up to transfer the powdery material from the storage container into a powder bed in the construction container to transfer;
e) a beam generator which is set up to direct an energy beam, in particular an electron beam, onto laterally different locations of the powder bed in the process chamber;
wherein
f) the powder application device can be removed from the process chamber.

12. The system according to claim 11, wherein the system comprises at least one movable receiving device having the construction container (40), the storage container and the powder application device.

13. The system according to claim 12, wherein the at least one movable receiving device can be transported from the process chamber into the process chamber and out of it.

14. The system according to claim 12, wherein the at least one movable receiving device is designed to accommodate construction containers and/or storage containers with different dimensions, in particular of different volumes.

15. The system according to claim 11, wherein all components coming into contact with the process can be removed from the process chamber.

16. A movable receiving device for a system for the additive manufacture of a workpiece from a powdery material, comprising:
a construction container in which the workpiece can be produced in layers, wherein
a) the movable receiving device has a powder application device which is set up to transfer the powdery material from a storage container into a powder bed to be transferred in the construction container.

17. The movable receiving device according to claim 16, wherein the storage container for the powdery material is part of the movable receiving device.

18. The movable receiving device according to claim 16, wherein the receiving device comprises a support frame which has at least two thermally decoupled sections.

19. The movable receiving device according to claim 16, wherein the construction container and the powder application device are attached to different sections of the support frame.

20. A method for the additive manufacture of a workpiece, comprising the steps of:
a) providing a beam system according to claim 11;
b) producing a workpiece by processing the powdery material by means of an energy beam in the process chamber; and
c) removing the powder application device from the process chamber.
